(19) United States
(12) Patent Application Publication
(10) Pub. No.: US 2023/0008251 A1
(43) Pub. Date: Jan. 12, 2023

(54) SYSTEM AND METHOD FOR EXPEDITED TILE INSTALLATION

(71) Applicant: Arka Energy Inc., Union City, CA (US)

(72) Inventors: Suryanarayana Murthy POTHARAJU, Union City, CA (US); Chethana Gopalago WDA, Bangalore (IN)

(21) Appl. No.: 17/861,624

(22) Filed: Jul. 11, 2022

(30) Foreign Application Priority Data
Jul. 10, 2021 (IN) 202111031051

(51) Int. Cl. E04F 15/02

(52) U.S. Cl. CPC E04F 15/02133; E04F 2201/0517

(57) ABSTRACT

A system and method for expedited tile installation are disclosed. The system may include a clamp strip and at least one tile. The clamp strip may be made of conjoined foldable strips. Each strip may include one or more clamps. The clamp strip role may be configured to unroll on a surface. The clamp strip may be adhered to the surface, after unrolling, using one or more fastening mechanisms. The at least one tile may include one or more wedges fixed to a rear side of the at least one tile. Each wedge may be configured to be inserted into the one or more clamp for installing the at least one tile. The one or more clamps and the one or more wedges may be configured to interlock for gripping the at least one tile to the clamp strip.

### CROSS-REFERENCE TO RELATED APPLICATIONS

This application claims priority to India Application No. 202111031051, filed Jul. 10, 2021, the disclosure of which is incorporated herein by reference.

### TECHNICAL FIELD

The present disclosure relates generally to tile installation. More specifically, it relates to a system and method for expedited installation of a tile.

### BACKGROUND

Background description includes information that may be useful in understanding the present invention. It is not an admission that any of the information provided herein is prior art or relevant to the presently claimed invention, or that any publication specifically or implicitly referenced is prior art.

Conventional mounting methods for roof tiles, such as solar or glass tiles, include rails and custom flashing or individual clamps tailored to a solar tile. The conventional mounting method involves the set of flashings, rails or the clamps being bolted down to the roof, one at a time, which results in more time to enable proper alignment of each tile with the surrounding group of tiles. Further, the conventional method requires that the flashing or clamp position be determined related to the adjacent tiles and then bolted down, which again requires more time and effort to achieve the right alignment and fit.

It is required that the tile mounting method significantly reduce the time to install the tiles, eliminate the need to check the alignment and fit for each tile, provide a robust clamping mechanism to install the roof solar or glass tiles, and a mechanism to arrest the tile movement in any direction after installation.

Therefore, there is a need to provide a system and method for efficient and expedited tile installation which can obviate aforementioned limitations in the art.

### OBJECTS OF THE INVENTION

A general object of the present disclosure is to provide a system and method for tile installation which obviates the above mentioned limitations of conventional tile mounting systems.

An object of the present disclosure is to provide a system and method to significantly reduce the time to install one or more tiles.

An object of the present disclosure is to provide a tile installation system and method to eliminate the need to check alignment, measurement, or fit for one or more tiles.

Another object of the present disclosure is to provide a system and method based on a robust clamping mechanism to install the roof solar or glass tiles.

Another object of the present disclosure is to provide a tile installation system and method that facilitates use of standard length rails which may be cut on site according to requirement.

Another object of the present disclosure is to provide a tile installation system and method for easy and expedited tile installation that can be implemented with any shape or size of the roof.

Yet another object of the present disclosure is to provide a system and method for using a flexible strip and wedge based tile mounting mechanism for easy and expedited tile installation.

Still another object of the present disclosure is to provide an improved clamp design that facilitates easy and expedited tile installation.

Still yet another object of the present disclosure is to provide an improved clamp design that includes one or more cabled holding clips to facilitate integrated cable management.

Still another object of the present disclosure is to provide a mechanism which arrest tile movement in all direction once installed.

### SUMMARY

Aspects of the present disclosure relate to a system for expedited tile installation. The system may include at least one clamp strip made of a plurality of conjoined foldable strips; wherein each of the plurality of foldable strips may include one or more clamps, wherein the at least one clamp strip may be adhered to a surface using one or more fastening mechanisms. The system may also include at least one tile with one or more wedges fixed to a rear side of the at least one tile, each of the one or more wedges may be configured to be inserted into a corresponding clamp of the clamp strip for installing the at least one tile. The one or more clamps and the one or more wedges maybe configured to interlock for gripping the at least one tile to the at least one clamp strip.

In an embodiment, the at least one clamp strip may be in a roll shape, and the roll of the at least one clamp strip may be unrolled for being laid on the surface.

In another embodiment, the one or more fastening mechanisms for adhering the at least one clamp strip to the surface include at least one of gluing and bolting/screwing.

In another embodiment, the at least one clamp strip may include one or more openings for fastening one or more bolts/screws for adhering the at least one clamp strip to the surface.

In another embodiment, the wedges along one side of the tile may have a height different from height of the wedges along the opposite side of the tile, wherein wedges of different height on opposite sides may enable installation of adjacent tiled in overlapping configuration.

In yet another embodiment, the one or more wedges may be either triangular or rectangular in shape, and the one or more clamps may have corresponding shape to enable interlocking of the wedges and the corresponding clamps.

Aspects of the present disclosure relate to a method for expedited tile installation. The method may include providing at least one clamp strip made of a plurality of conjoined foldable strips. Each of the plurality of foldable strips may include one or more clamps, wherein the at least one clamp strip may be adhered to a surface using one or more fastening mechanisms. The method may include providing at least one tile with one or more wedges fixed to a rear side of the at least one tile, each of the one or more wedges may be configured to be inserted into a corresponding clamp of the clam strip for installing the at least one tile. The method may also include adhering the at least one clamp strip to the surface using one or more fastening mechanisms, and positioning the at least one tile on the at least one clamp strip for interlocking the one or more clamps with the one or more wedges for gripping the at least one tile to the at least one clamp strip.

In an embodiment, the at least one clamp strip may be provided in rolled shape.

In another embodiment, the at least one clamp strip may be unrolled to lay out the at least one clamp strip on the surface.

In yet another embodiment, two adjacent tiles may be installed in an overlapping configuration, wherein the overlapping configuration may be achieved by providing the wedges along one side of the tile with a height different from height of the wedges along the opposite side of the tile.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIGS. 1A and 1B illustrate diagrammatic representations of rolled and unrolled views respectively of a custom clamp strip, in accordance with embodiments of the present disclosure.

FIGS. 2A-2D illustrate diagrammatic representations of clamps included in the custom clamp strip, in accordance with embodiments of the present disclosure.

FIGS. 3A-3C illustrate diagrammatic representations of tile wedges and interlocking of the wedges with clamps, in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Embodiments explained herein relate to a tile mounting system. More specifically, it relates to a system for installing solar roof tiles on roof tops.

In an embodiment, a proposed system and method for roof solar tile or glass tile installation process to rapidly install a solar roof is described. The proposed system may include key system components such as one or more clamp strips, one or more tiles, and the like. The components may be custom built to facilitate the quick installation of the solar roof. The one or more clamp strips may include a custom clamp strip (herein after interchangeably referred to as “CCS” or “clamp strip”). The one or more tiles may include solar tiles with wedges (herein after interchangeably referred to as “PVT”), or Glass tiles with wedges (herein after interchangeably referred to as “GT”).

In another embodiment, the CCS may include one or more conjoined foldable strips, which may be made of soft polymer material. Each of the one or more conjoined foldable strips may include one or more clamps into which the PVT or GT can be wedged into.

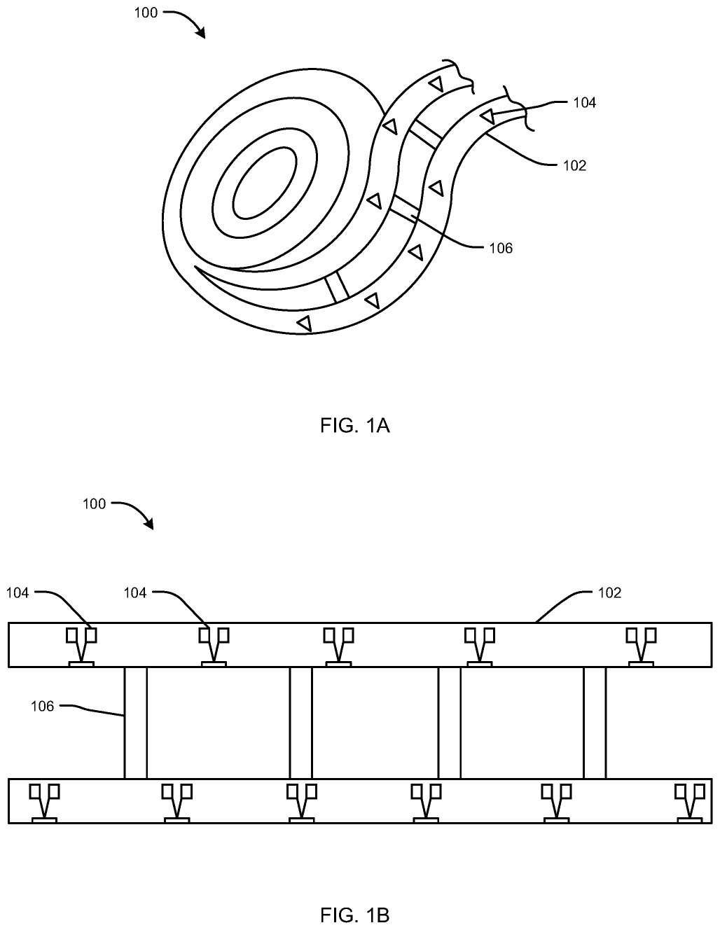

FIGS. 1A and 1B illustrate diagrammatic representations of rolled and unrolled views respectively of a custom clamp strip, in accordance with embodiments of the present disclosure.

FIG. 1A illustrates a folded or bundled view of the custom clamp strip (CCS) 102. FIG. 1B illustrates an unrolled or unbundled view of the CCS 102. As illustrated in FIGS. 1A and 1B, the CCS 100 may include multiple conjoined foldable strips 106. The CCS 102 may be configured to unroll or unfold for laying out on the roof post the underlayment and firmly adhered to the roof with any or a combination of gluing and bolting down with at least two clamps 104. The metallic clamps 104 may provide a slit or opening to bolt through with a screw 202 that can hold the CCS 102 down once installed.

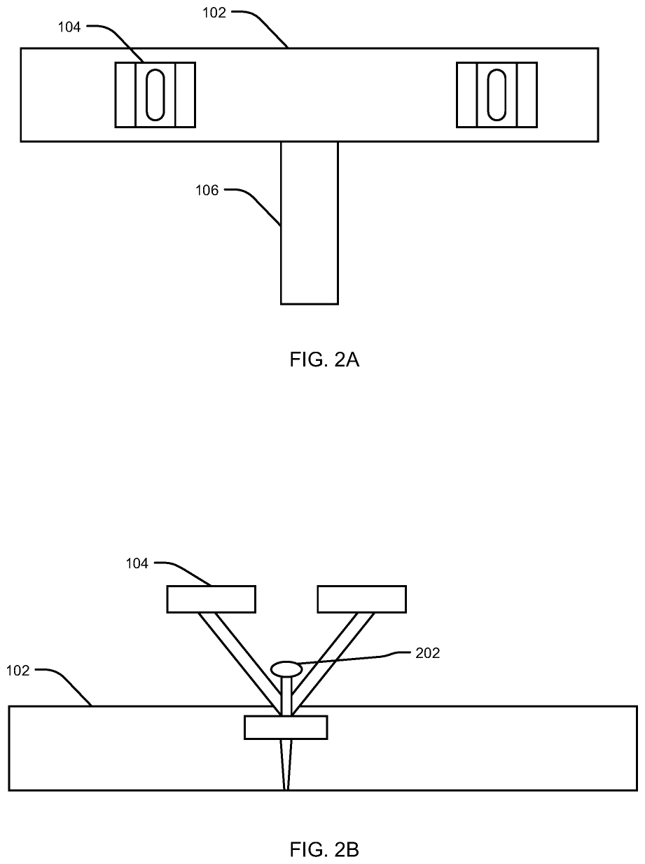

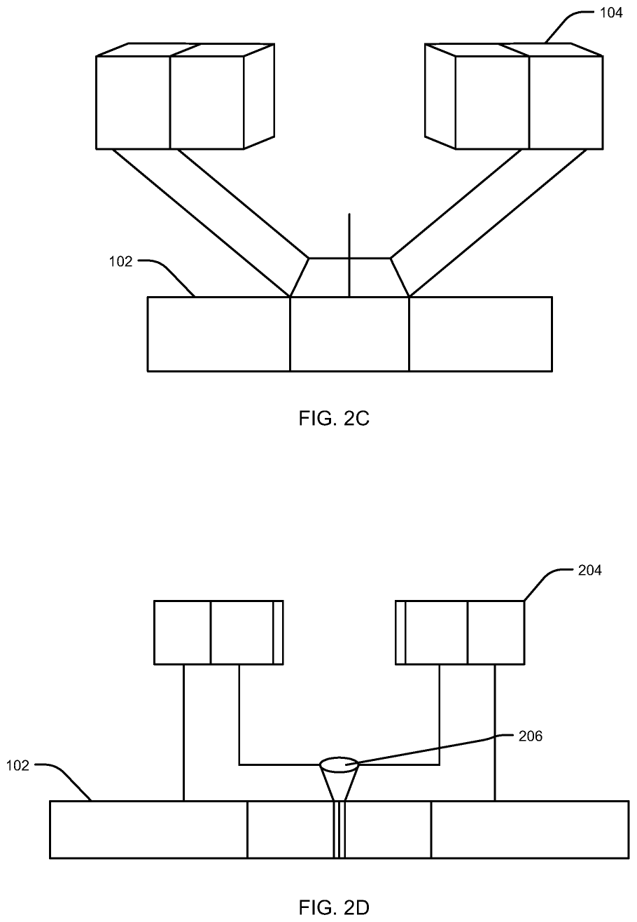

FIGS. 2A-2D illustrate diagrammatic representations of clamps included in the custom clamp strip, in accordance with embodiments of the present disclosure.

FIG. 2A illustrates a close up view of the CCS 102 from the top which depicts a plurality of clamps 104. FIG. 2B illustrates a side view of a clamp 104 embedded in CCS 102. A screw 202 may be fastened at the centre of the clamp 104 to attach the CCS 102 with the roof surface. Additionally, or alternatively, other fastening mechanisms such as adhesive or adhesive tapes may also be used. The clamps 104 may be of any shape and size. A two-dimensional triangular view of the clamp 104 is illustrated in FIG. 2B which is an exemplary view of the shape of the clamp 104, a possible alternative may be a rectangular view of the shape as depicted in FIG. 2D. A person having ordinary skill in the art would understand that the clamp 104 may be of any size or shape. FIG. 2C illustrates an isometric view of the clamp 104 embedded in the CCS 102. FIG. 2D also depicts a hole or opening 206 for fastening the screw 202.

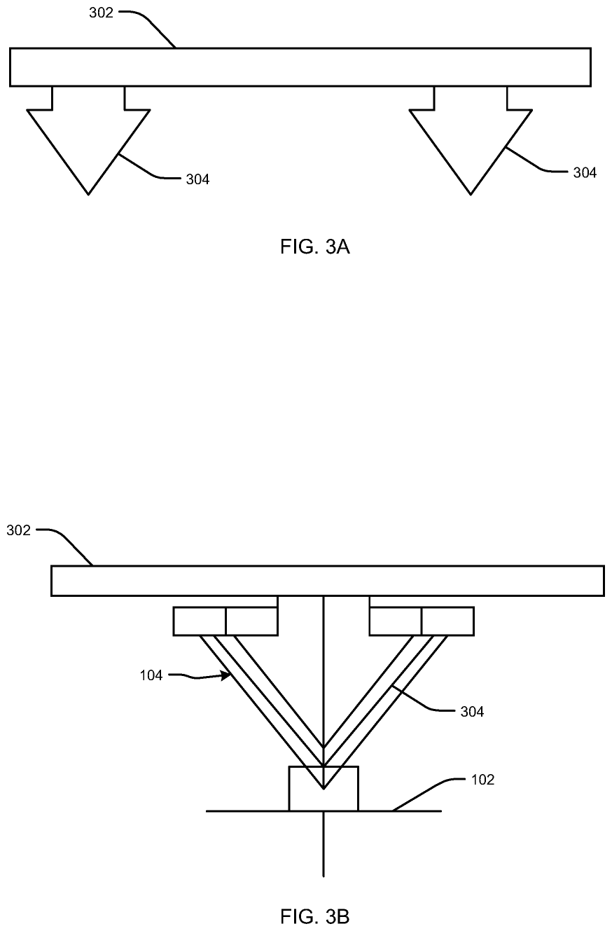

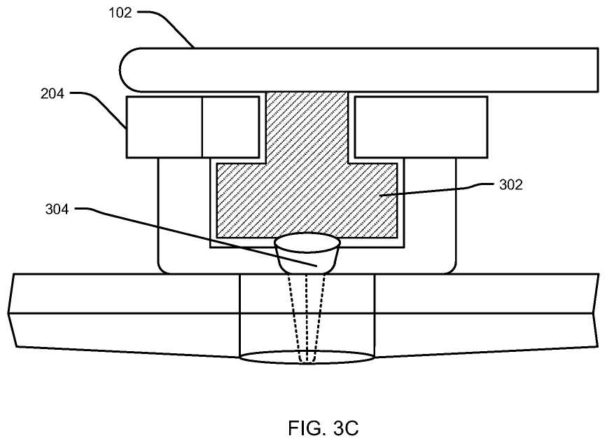

FIGS. 3A-3C illustrate diagrammatic representations of tile wedges and interlocking of the wedges with clamps, in accordance with embodiments of the present disclosure.

FIG. 3A illustrates a tile 302 which may be either a PVT or GT. The PVT or GT tile 302 may include one or more wedges 304. Although FIG. 3A illustrates two wedges 304 attached to a rear side of the PVT or GT tile 302, the PVT or GT tile 302 may include more or less number of wedges 304. Further, the view of the one or more wedges 304 as depicted in FIG. 3A is an exemplary view which is provided only for the purpose of illustration and understanding various embodiments disclosed herein. A person having ordinary skill in the art would understand that the one or more wedges 304 may be of any size or shape and may be attached at any other position or angle on the PVT or GT tile 302.

FIG. 3B illustrates an interlocked state of a wedge 304 of the PVT or GT tile 302 with a clamp 104 of the CCS 102. The clamps 104 on the CCS 102 and wedges 304 on the PVT or GT tiles 302 are designed to interlock for holding the PVT or GT tile 302 tightly gripped by the CCS 102. The wedges 304 could be of any shape or size. The wedges 304 and clamps 104 can remain complementary to interlock and firmly hold the PVT or GT tile 302 with the CCS 102. In an exemplary embodiment, FIG. 3C illustrates interlocking of a rectangular shaped clamp 104 with a rectangular shaped wedges 304.

In an embodiment, an assembly process with CCS and wedged PVT/GT could include various steps. In a first step, a bottom strip of the CCS may be aligned to lower edge of the roof. In a second step, adhesion covering the bottom strip may be removed, if required, and the strip may be unrolled over the roof surface. Next, a subset of the clamps (e.g., half or two-thirds of the clamps) may be bolted to the roof starting with the edge clamps. Further, the PVT/GT may be installed by pushing them into the clamps. Finally, a row height marking tool may be used to mark next position of the strip. The sequence of steps starting from the second step may be repeated to continue installation of more PVT/GT until all the PVT/GT have been installed.

In an embodiment, the proposed system and method may address several key requirements to significantly reduce the time needed to install a solar roof. The key requirements may include measurement and alignment for each tile, standard length rails that may need to be cut on site, fit any shape of the roof with strip rolled across, and speed up installation with PVT/GT wedged once strip is placed.

In another embodiment, each wedge of a tile can be of different profile height to allow for tiles to be placed in an overlapping configuration and provide seamless layering of PVT/GT. Further, the clamp designs can also be enhanced to include cabled holding clips to facilitate integrated cable management.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

As used herein, and unless the context dictates otherwise, the term “coupled to” is intended to include both direct coupling (in which two elements that are coupled to each other contact each other)and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

### ADVANTAGES OF THE INVENTION

The present disclosure provides a system and method for tile installation which obviates the above mentioned limitations of conventional tile mounting systems.

The present disclosure provides a system and method to significantly reduce the time to install one or more tiles.

The present disclosure provides a tile installation system and method to eliminate the need to check alignment, measurement, or fit for one or more tiles.

The present disclosure provides a system and method based on a robust clamping mechanism to install the roof solar or glass tiles.

The present disclosure provides a tile installation system and method for facilitate use of standard length rails which may be cut on site according to requirement.

The present disclosure provides a system and method to adjust with any shape or size of the roof for easy and expedited tile installation.

The present disclosure provides a system and method for using a flexible strip and wedge based tile mounting mechanism for easy and expedited tile installation.

The present disclosure provides a system and method to facilitate a clamp design to include one or more cabled holding clips to facilitate integrated cable management.

The present disclosure provides a system and method based on a robust clamping mechanism to Arrest all movement of the tile once installed.

I/We claim:

1. A system for expedited tile installation, the system comprising:
at least one clamp strip made of a plurality of conjoined foldable strips, wherein each of the plurality of foldable strips comprises one or more clamps, wherein the at least one clamp strip is adhered to a surface using one or more fastening mechanisms; and
at least one tile with one or more wedges fixed to a rear side of the at least one tile, each of the one or more wedges being configured to be inserted into a corresponding clamp of the clam strip for installing the at least one tile;
wherein the one or more clamps and the one or more wedges are configured to interlock for gripping the at least one tile to the at least one clamp strip.

2. The system as claimed in claim 1, wherein the at least one clamp strip is in a roll, wherein the roll of the at least one clamp strip is configured to be unrolled for being laid on the surface.

3. The system as claimed in claim 1, wherein said one or more fastening mechanisms for adhering the at least one clamp strip to the surface include at least one of glue, a bolt, a screw, or combinations thereof.

4. The system as claimed in claim 3, wherein the at least one clamp strip includes one or more openings for fastening one or more bolt, screw, or combinations thereof, for adhering the at least one clamp strip to the surface.

5. The system as claimed in claim 1, wherein the one or more wedges along one side of the tile have a height different from a height of the one or more wedge along an opposite side of the tile, wherein the one or more wedges of a different height on the opposite side enables installation of adjacent tiles in an overlapping configuration.

6. The system as claimed in claim 1, wherein the one or more wedges are either triangular or rectangular in shape, wherein the one or more clamps have a corresponding shape to enable interlocking of the one or more wedges and the corresponding one or more clamps.

7. A method for expedited tile installation, the method comprising:
providing at least one clamp strip made of a plurality of conjoined foldable strips, wherein each of the plurality of foldable strips comprises one or more clamps, wherein the at least one clamp strip is adhered to a surface using one or more fastening mechanisms; and
providing at least one tile with one or more wedges fixed to a rear side of the at least one tile, each of the one or more wedges being configured to be inserted into a corresponding one or more clamp of the clam strip for installing the at least one tile;
adhering the at least one clamp strip to the surface using one or more fastening mechanisms; and
positioning the at least one tile on the at least one clamp strip for interlocking the one or more clamps with the one or more wedges for gripping the at least one tile to the at least one clamp strip.

8. The method as claimed in claim 7, wherein the at least one clamp strip is in a rolled shape.

9. The method as claimed in claim 8, further comprising unrolling the at least one clamp strip to lay out the at least one clamp strip on the surface.

10. The method as claimed in claim 7, further comprising installing two adjacent tiles in an overlapping configuration, wherein the overlapping configuration is achieved by providing the one or more wedges along one side of the tile with a height different from a height of the one or more wedges along an opposite side of the tile.
